(19) United States
(12) Patent Application Publication
(10) Pub. No.: US 2020/0031277 A1
(43) Pub. Date: Jan. 30, 2020

(54) ELECTRONIC DEVICE AND METHOD FOR ISSUING WARNINGS AS TO DRIVING SAFETY

(71) Applicant: Chiun Mai Communication Systems, Inc., New Taipei (TW)

(72) Inventor: PO-YEN LIU, New Taipei (TW)

(21) Appl. No.: 16/521,661

(22) Filed: Jul. 25, 2019

(30) Foreign Application Priority Data
Jul. 27, 2018 (CN) 201810844365.0

(51) Int. Cl. B60Q 9/00; G06T 7/70; B60Q 5/00

(52) U.S. Cl. CPC B60Q 9/008; G06T 7/70; B60Q 5/006; H04N 5/247; G06T 2207/30201; G06T 2207/30252; G06T 2207/20021; G06T 2207/30268

(57) ABSTRACT

A method for issuing warnings to a driver as to the presence of objects in the path of his vehicle which are possibly dangerous includes steps of obtaining an image of eyes of a driver and an image of scene in front of the vehicle and detecting coordinate of pupils of the driver's eyes. The pupils coordinate is converted into coordinate of parts or points of the view in front of the vehicle. Any object within a preset distance in front of the vehicle is searched for and if found the method determines whether the pupils coordinate is within or outside a safety range around the object. A warning signal is output when the view coordinate is outside the safety range around the object in the front scene image. An electronic device is also provided.

### FIELD

The subject matter herein generally relates to road traffic safety.

### BACKGROUND

Traffic accident can occur when a driver is tired and/or distracted. There are many ways to alert tired and/or distracted drivers, such as a refreshing drink, chewing gum, listening to music, chatting with other persons, pinching oneself to maintain concentration. However, these methods are relatively risky when only one person is driving.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout several views.

FIG. 1 is a system architecture diagram of an electronic device according to an embodiment of the present disclosure.

FIG. 2 is a block diagram of a driving safety warning system applied to the electronic device of FIG. 1.

FIG. 3 is a flowchart of a method for warning as to driving safety.

FIG. 4 is a schematic view of a projection of a front scene of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

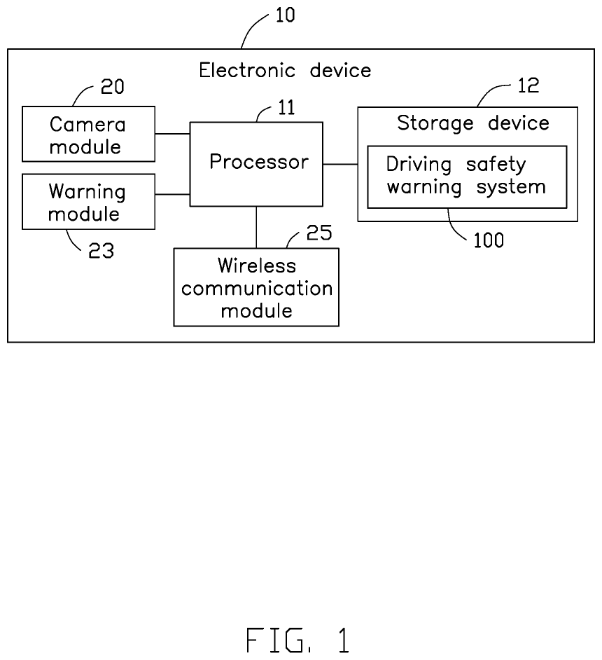

FIG. 1 illustrates an electronic device 10. As illustrated in FIG. 1, the electronic device 10 can be installed in a vehicle. In this embodiment, the electronic device 10 includes, but is not limited to, at least one processor 11, a storage device 12, a camera module 20, a warning module 23, and a wireless communication module 25.

The processor 11 can be a central processing unit (CPU), a microprocessor, or other chips having data processing functions.

The storage device 12 may be a storage device of the electronic device 10 itself. In other embodiments, the storage device 12 may be an external storage device, such as a smart media card, a secure digital card, a flash card, or the like. The storage device 12 is equipped with a driving safety warning system 100.

The camera module 20 is configured to capture a scene image of a driver of the vehicle (for example, an eyes image of the driver) and an image of the scene in front of the vehicle. The camera module 20 further stores the captured images in the storage device 12.

In one embodiment, the camera module 20 includes a first camera and a second camera. The first camera is used to capture the scene image in front of the vehicle. The second camera is used to capture a scene image of the driver.

In other embodiments, the camera module 20 is used for capturing the scene image of the driver. The scene image in front of the vehicle is captured by an electronic equipment (not shown). The electronic device 10 can be wirelessly connected to the electronic equipment through the wireless communication module 25 for acquiring the scene image in front of the vehicle captured by the electronic equipment. The electronic equipment may be other device having a photographing function, such as a driving recorder.

In other embodiments, the camera module 20 can be omitted. That is, the electronic device 10 does not need to include the camera module 20. The electronic device 10 acquires the scene image of the driver and the scene image in front of the vehicle by connecting to the electronic equipment. The electronic device 10 can be wirelessly connected to the electronic equipment through the wireless communication module 25 for acquiring the scene image of the driver and the scene image in front of the vehicle captured by the electronic equipment.

The warning module 23 is configured to output a warning signal to the driver. The signal may be a warning sound, the warning sound being pre-stored in the electronic device 10.

The wireless communication module 25 is used for communication between the electronic device 10 and the electronic equipment or a wireless network (not shown). The wireless communication module 25 can be a WI-FI module, a BLUETOOTH module, a ZIGBEE module, or other wireless communication module.

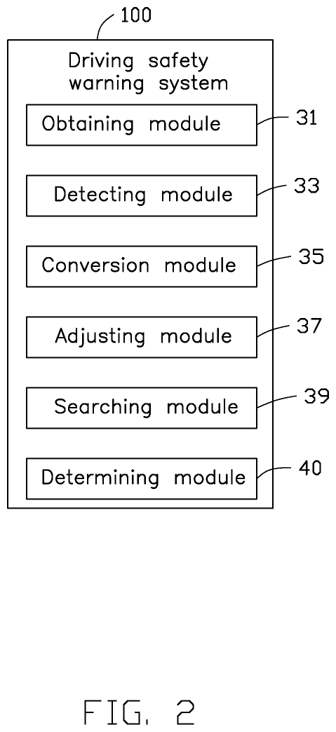

Referring to FIG. 2, the driving safety warning system 100 includes a number of modules, which are a collection of software instructions stored in the storage device 12 and are executed by the processor 11, to enable functions of the electronic device 10.

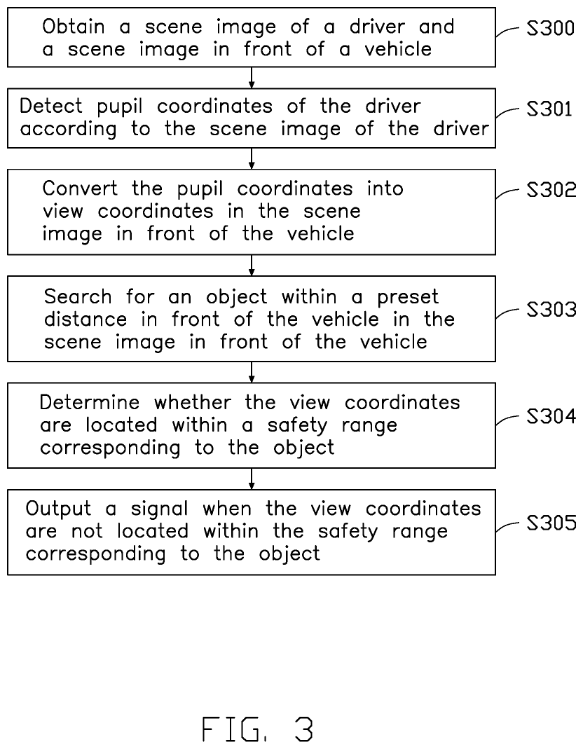

The driving safety warning system 100 includes an obtaining module 31, a detecting module 33, a conversion module 35, an adjusting module 37, a searching module 39, and a determining module 40. The modules referred to in the present disclosure may be a program segment for performing a specific function, and is more suitable than the program to describe an execution process of the software in the electronic device 10. The functions of each module are described in conjunction with the flowchart of FIG. 3.

As illustrated in FIG. 3, the method for warning as to driving safety is provided by way of example, as there are a variety of ways to carry out the method. Each block shown in FIG. 3 represents one or more processes, methods, or subroutines carried out in the example method. Additionally, the illustrated order of blocks is by example only and the order of the blocks can be changed. The example method can begin at block S300.

At block S300, an obtaining module 31 obtains a scene image of the driver (for example, an eyes image of the driver) and a scene image in front of the vehicle.

In this embodiment, the driver can modify a position of the electronic device 10, so that the camera module 20 of the electronic device 10 can capture the scene image of the driver and the scene image in front of the vehicle.

In one embodiment, the camera module 20 is a lens which is capable being modified for direction and angle. The obtaining module 31 obtains the scene image of the driver and the scene image in front of the vehicle captured by the camera module 20.

In other embodiments, the electronic device 10 is wirelessly connected to the electronic equipment. The obtaining module 31 obtains the scene image in front of the vehicle captured by the electronic equipment. The obtaining module 31 obtains the scene image of the driver captured by the camera module 20. The electronic device 10 can communicate with the electronic equipment through the wireless communication module 25.

In other embodiments, the electronic device 10 is wirelessly connected to the electronic equipment. The obtaining module 31 obtains the scene image in front of the vehicle and the scene image of the driver captured by the electronic equipment. The electronic equipment includes a first camera and a second camera. The first camera is configured to capture the scene image in front of the vehicle. The second camera is configured to capture the scene image of the driver.

At block S301, a detecting module 33 detects coordinates of pupils of the eyes of the driver according to the scene image, that is, the coordinates of the driver's pupils in the scene image.

At block S302, a conversion module 35 converts the pupil coordinates into a coordinate of the view in scene image in front of the vehicle. The view coordinates can indicate a position of the pupil coordinates in relation to the scene in scene image in front of the vehicle, that is, a point or position that the driver is looking at.

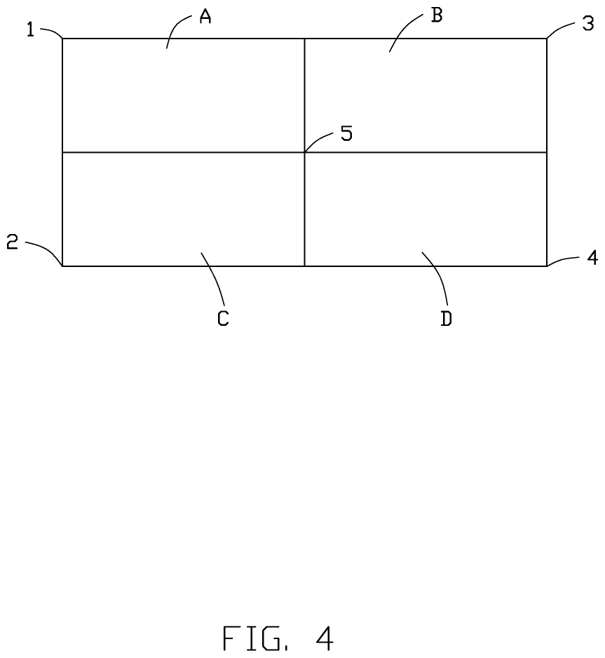

In one embodiment, the scene in front of the vehicle can be divided into four, six, or eight or more areas. In this embodiment, as shown in FIG. 4, a center 5 of a front scene and/or a scene image in front of the vehicle is taken as an origin. The front scene and/or the front scene image are divided into four areas through a plane rectangular coordinate system. The four areas are a first area A, a second area B, a third area C, and a fourth area D. A first point 1, a second point 2, a third point 3, and a fourth point 4 are in the corners of the four areas, and a fifth point 5 is at the center. The driver can be guided or advised to focus on any one of the points 1-5. The first point 1 is positioned at an upper left corner of the first area A. The second point 2 is positioned at a lower left corner of the third area C. The third point 3 is positioned at an upper right corner of the second zone B. The fourth point 4 is positioned at a lower right corner of the fourth zone D. The fifth point 5 is a point where the four areas intersect.

In one embodiment, the driver can focus his eyes to a center point and four corner points of a windshield of the vehicle. The detecting module 33 detects the pupil coordinates when the driver views the front scene of the vehicle through the first point 1, the second point 2, the third point 3, the fourth point 4, and the fifth point 5. According to the pupil coordinates and a linear interpolation method, the conversion module 35 calculates a mapping relationship between the pupil coordinates of the scene image of the driver and the view coordinates of the scene image in front of the vehicle.

In one embodiment, the mapping relationship may be a mapping table pre-stored in the electronic device 10. The conversion module 35 can perform conversion based on the mapping table, and converts the pupil coordinates of the scene image of the driver into the view coordinates of the scene image in front of the vehicle.

At block S303, a searching module 39 searches for an object within a preset distance of the front of the vehicle in the scene image in front of the vehicle. The object may be an object which is a potential danger, such as a person, an animal, an obstacle, or the like. The searching module 39 determines a distance of such object in front of the vehicle according to a focal length obtained when capturing the scene image in front of the vehicle.

In one embodiment, the electronic device 10 includes a positioning system, such as a Global Positioning System (GPS), for acquiring vehicle speed information of the vehicle. The adjusting module 37 obtains the current vehicle speed information and modifies the preset distance according to the current vehicle speed information. The vehicle speed information may be a driving speed of the vehicle. For example, when the driving speed of the vehicle is high, the adjusting module 37 can modify the preset distance to be longer. When the driving speed is low, the adjusting module 37 can modify the preset distance to be shorter. The searching module 39 searches for any object within the preset distance in scene image in front of the vehicle.

In other embodiments, the electronic device 10 does not include the positioning system. The preset distance may be a fixed value, such as 20 m, 30 m, 50 m, or the like. The preset distance may be pre-stored in the storage device 12 or may be set by the driver at any time, through the adjusting module 37. The searching module 39 searches for any object within the preset distance in the scene image in front of the vehicle.

At block S304, a determining module 40 determines whether the view coordinate is located within a safety range corresponding to the object within a preset distance in front of the vehicle. The safety range is a preset range of the scene image in front of the vehicle. If the view coordinate is outside the safety range, the driver is taken to be inattentive in relation to the object, the driver may be driving dangerously.

In one embodiment, the safety range may be a circular area with a radius of a preset value centered on the object.

In other embodiments, the scene image in front of the vehicle is divided into a plurality of areas. Then the safety range may be an area in which the object is located. As shown in FIG. 4, for example, an animal in front is in the first zone A, and the determining module 40 determines whether the view coordinate of the driver is in the first area A. If the view coordinate of the driver is located in the first area A, it is determined that the view coordinate is within the safety range. If the determining module 40 determines that the view coordinate is outside the safety range, the driver is taken to be inattentive.

At block S305, a warning module 23 outputs a signal when the view coordinate is not located within the safety range corresponding to the object. The signal may be a warning sound, the warning sound being pre-stored in the electronic device 10.

In one embodiment, when the determining module 40 determines that the view coordinate of the scene image in front of the vehicle is outside the safety range corresponding to the object, the warning module 23 will output the signal to warn the driver.

In other embodiments, the detecting module 33 can also determine whether the driver is driving dangerously through the pupil coordinates of the driver. Specifically, when the detecting module 33 does not detect the pupil coordinates, it may be taken that the eyes of the driver are closed, or that he may be looking at other areas. In such situation, the driver may be taken to be driving dangerously, and the warning module 23 outputs the warning signal to the driver. When the detecting module 33 detects that the pupil coordinates of the driver has not changed for a predetermined period of time, the driver may be taken to be concentrating on, or thinking about something else. The warning module 23 will herein output the warning signal.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. An electronic device, the electronic device comprises:
a processor; and
a storage device storing one or more programs operable to make the processor to:
obtain a scene image of a driver and a scene image in front of a vehicle;
detect a pupil coordinates of the driver according to the scene image of the driver;
convert the pupil coordinates into view coordinates in the scene image in front of the vehicle;
search for an object within a preset distance of the front of the vehicle in the scene image in front of the vehicle;
determine whether the view coordinates are located within a safety range corresponding to the object; and
output a signal when the view coordinates are not located within the safety range corresponding to the object.

2. The electronic device of claim 1, further comprising a camera module, wherein the camera module captures the scene image of the driver.

3. The electronic device of claim 2, wherein the camera module further captures the scene image in front of the vehicle.

4. The electronic device of claim 1, further comprising a wireless communication module, wherein the electronic device is connected to an electronic equipment through the wireless communication module to obtain the scene image in front of the vehicle captured by the electronic equipment.

5. The electronic device of claim 1, wherein the one or more programs further operable to make the processor to:
obtain current vehicle speed information; and
modify the preset distance according to the current vehicle speed information.

6. The electronic device of claim 1, wherein the safety range is a circular area with a radius of a preset value centered on the object.

7. The electronic device of claim 1, wherein the scene image in front of the vehicle is divided into a plurality of areas, and the safety range is an area in which the object is located.

8. The electronic device of claim 1, wherein the one or more programs further operable to make the processor to:
output the signal when the pupil coordinates are not detected.

9. The electronic device of claim 1, wherein the one or more programs further operable to make the processor to:
output the signal when the pupil coordinates of the driver have not changed for a predetermined period of time.

10. A method for warning as to driving safety, the method comprises:
obtain an scene image of a driver and a scene image in front of a vehicle;
detect pupil coordinates of the driver according to the scene image of the driver;
convert the pupil coordinates into view coordinates in the scene image in front of the vehicle;
search for an object within a preset distance of the front of the vehicle in the scene image in front of the vehicle;
determine whether the view coordinates are located within a safety range corresponding to the object; and
output a signal when the view coordinates are not located within the safety range corresponding to the object.

11. The method of claim 10, further comprising:
obtain current vehicle speed information; and
modify the preset distance according to the current speed of the vehicle.

12. The method of claim 10, wherein the safety range is a circular area with a radius of a preset value centered on the object.

13. The method of claim 10, wherein the scene image in front of the vehicle is divided into a plurality of areas, and the safety range is an area in which the object is located.

14. The method of claim 10, further comprising:
output the signal when the pupil coordinates are not detected.

15. The method of claim 10, further comprising:
output the signal when the pupil coordinates of the driver have not changed for a predetermined period of time.
